(19) United States
(12) Patent Application Publication
(10) Pub. No.: US 2025/0242627 A1
(43) Pub. Date: Jul. 31, 2025

(54) STITCHING AND FOLDING APPARATUS AND CONTROL METHOD OF STITCHING AND FOLDING APPARATUS

(71) Applicant: Horizon Inc., Takashima-shi (JP)

(72) Inventor: Masayuki KASHIBA, Takashima-shi (JP)

(73) Assignee: Horizon Inc., Takashima-shi (JP)

(21) Appl. No.: 19/025,034

(22) Filed: Jan. 16, 2025

(30) Foreign Application Priority Data
Jan. 31, 2024 (JP) 2024-013611

(51) Int. Cl. B42B 2/02; B42B 4/00; B65H 37/04; B65H 37/06

(52) U.S. Cl. CPC B42B 2/02; B42B 4/00; B65H 37/04; B65H 37/06

(57) ABSTRACT

Provided is a stitching and folding apparatus in which a stitch mechanism has a transport unit, a stitcher that binds a sheet bundle at a binding position in the transport direction, a pair of guide members that restrict a position in the width direction of the sheet bundle, and a guide motion unit that moves the pair of guide members in the width direction, the transport unit is arranged in a region where the sheet bundle transported from a collating machine is arranged, and a control unit controls the guide motion unit so that the stitcher is arranged at an intermediate position in the width direction between the pair of guide members and controls the stitcher to bind the sheet bundle at the binding position with the stitcher being arranged at the intermediate position and arranged at a different position from a region where the transport unit is arranged.

This nonprovisional application claims priority to Japanese Patent Application No. 2024-013611 filed on Jan. 31, 2024, and herein incorporated by reference in its entirety.

### BACKGROUND OF THE INVENTION

### Field of the Invention

The present invention relates to a stitching and folding apparatus and a control method of a stitching and folding apparatus.

### Description of Background Art

Stitching and folding apparatuses in which a sheet bundle transported from a collating machine is bound at the center part in the transport direction with a wire by a stitcher and the sheet bundle bound with the wire is folded in two at the center part to make a book are conventionally known (for example, Japanese Patent Application Laid-Open No. 2009-279799). Japanese Patent Application Laid-Open No. 2009-279799 discloses that a sheet bundle carried in from a collating machine is transported by a transport belt, and the sheet bundle is stopped at a predetermined position and bound with a wire by a stitcher.

In stitching and folding apparatuses, to suitably transport and stitch various sizes of sheet bundles carried in from a collating machine, it is preferable to arrange the transport belt so that a sheet bundle having the possible smallest size that to be accepted can be transported in the width direction orthogonal to the transport direction of the sheet bundle.

For example, when sheet bundles are carried in from the collating machine such that the center position of various size of sheet bundles matches a predetermined position in the width direction, it is preferable to arrange the transport belt at a predetermined position in the width direction. In such a case, the position where the transport belt is arranged matches the center position in the width direction of the sheet bundle.

On the other hand, in stitching and folding apparatuses, it may be desired to apply a process to bind a sheet bundle with a wire at a single point at the center or multiple points (for example, three points) including the center of the back of a book made by folding the sheet bundle. In such a case, in a stitching and folding apparatus, it is required to bind the center position in the width direction of the sheet bundle by a stitcher. However, when the position where the transport belt is arranged is matched to the center position in the width direction of a sheet bundle, it is not possible to bind the sheet bundle at the center position in the width direction by the stitcher because of the presence of the transport belt.

The present invention has been made in view of the above problem and intends to provide a stitching and folding apparatus and a control method of a stitching and folding apparatus that can suitably bind a sheet bundle at the center position in the width direction of the sheet bundle while enabling transport of various sizes of sheet bundles.

### SUMMARY OF THE INVENTION

To solve the above problem, the present invention employs the following solutions. A stitching and folding apparatus according to one aspect of the present invention includes: a stitch mechanism configured to bind a sheet bundle at a predetermined binding position in a transport direction, the sheet bundle being transported in the transport direction from an upstream apparatus; a folding mechanism configured to fold, at the predetermined binding position, the sheet bundle bound at the predetermined binding position by the stitch mechanism; and a control unit configured to control the stitching and folding apparatus, the stitch mechanism has a transport unit formed extending in the transport direction, arranged in a predetermined region defined in a width direction orthogonal to the transport direction, and configured to transport, in the transport direction, the sheet bundle transported from upstream in the transport direction, a stitcher configured to bind the sheet bundle at the predetermined binding position in the transport direction, a pair of guide members arranged apart from each other with a distance in the width direction interposing the transport unit and configured to restrict a position in the width direction of the sheet bundle arranged on the transport unit, and a guide motion unit configured to move the pair of guide members in the width direction with respect to the transport unit and the stitcher, the transport unit is arranged in a region defined in the width direction, the sheet bundle transported from the upstream apparatus being arranged in the region, and the control unit is configured to control the guide motion unit so that the stitcher is arranged at an intermediate position in the width direction between the pair of guide members, and control the stitcher to bind the sheet bundle at the predetermined binding position with the stitcher being arranged at the intermediate position and being arranged at a different position from the predetermined region in which the transport unit is arranged.

According to the stitching and folding apparatus of one aspect of the present invention, the sheet bundle transported in the transport direction from the upstream apparatus is bound at the predetermined binding position by the stitch mechanism and folded at the predetermined binding position by the folding mechanism, and thereby a book can be made. Further, since the predetermined region in which the transport unit is arranged is included in the region defined in the width direction in which the sheet bundle transported from the upstream apparatus is arranged, various sizes of sheet bundles can be transported.

Further, the sheet bundle is bound at the predetermined binding position by the stitcher with the stitcher being arranged at the intermediate position in the width direction between the pair of guide members and being arranged at a different position from the predetermined region in which the transport unit that transports the sheet bundle is arranged. It is thus possible to suitably bind the sheet bundle at the center position in the width direction while preventing the stitcher from being arranged in the predetermined region in which the transport unit is arranged.

The stitching and folding apparatus according to one aspect of the present invention may be configured such that the control unit controls the guide motion unit so that the stitcher is arranged at the intermediate position with the sheet bundle being arranged between the pair of guide members, and control the stitcher to bind the sheet bundle at the predetermined binding position with the stitcher being arranged at the intermediate position.

According to the stitching and folding apparatus of the present configuration, the pair of guide members are moved so that, after the sheet bundle transported from the upstream apparatus is accepted between a pair of guide members, the stitcher is arranged at an intermediate position between the pair of guide members, and this makes it possible to suitably bind the sheet bundle at the center position in the width direction.

The stitching and folding apparatus of the above configuration may be formed such that the stitching and folding apparatus includes a motion mechanism configured to move the stitch mechanism in the width direction, and the control unit controls the motion mechanism so that the center position in the width direction of the sheet bundle transported from the upstream apparatus is arranged in the predetermined region.

According to the stitching and folding apparatus of the present form, the entire stitch mechanism including the transport unit, the stitcher, and the pair of guide members is moved in the width direction by the motion mechanism, and thereby the center position in the width direction of the sheet bundle transported from the upstream apparatus can be arranged in a predetermined region.

The stitching and folding apparatus according to one aspect of the present invention may be configured such that the stitching and folding apparatus includes a motion mechanism configured to move the stitch mechanism in the width direction, and the control unit controls the motion mechanism so that the stitcher is arranged at the center position in the width direction of the sheet bundle transported from the upstream apparatus and controls the stitcher to bind the sheet bundle at the predetermined binding position with the stitcher being arranged at the intermediate position.

According to the stitching and folding apparatus of the above configuration, the pair of guide members is moved so that the stitcher is arranged at an intermediate position between the pair of guide members before accepting the sheet bundle transported from the upstream apparatus between the pair of guide members, and this makes it possible to suitably bind the sheet bundle, which is accepted between the pair of guide members, at the center position in the width direction.

The stitching and folding apparatus of the above configuration may be formed such that the control unit controls the guide motion unit so that the center position in the width direction of the sheet bundle bound at the predetermined binding position by the stitcher is included in the predetermined region and controls the transport unit to transport the sheet bundle to the folding mechanism, the center position of the sheet bundle being arranged to be included in the predetermined region.

According to the stitching and folding apparatus of the present form, the sheet bundle moved in the width direction for binding the sheet bundle by the stitcher can be transported to the folding mechanism after returned to the position in the width direction applied when the sheet bundle is carried in from the upstream apparatus.

The stitching and folding apparatus according to one aspect of the present invention may be configured such that the stitch mechanism has a stitcher motion unit moves the stitcher in the width direction with respect to the transport unit, and the control unit controls the stitcher motion unit so that the stitcher is arranged at a different position from the predetermined region in which the transport unit is arranged.

According to the stitching and folding apparatus of the above configuration, the stitcher motion unit arranges the stitcher at a different position from the predetermined region in which the transport unit is arranged, and thereby it is possible to suitably prevent the stitcher from being arranged in the predetermined region in which the transport unit is arranged.

In a control method of a stitching and folding apparatus according to one aspect of the present invention, the stitching and folding apparatus has a stitch mechanism configured to bind a sheet bundle at a predetermined binding position in a transport direction, the sheet bundle being transported in the transport direction from an upstream apparatus and a folding mechanism configured to fold, at the predetermined binding position, the sheet bundle bound at the predetermined binding position by the stitch mechanism, the stitch mechanism has a transport unit formed extending in the transport direction, arranged in a predetermined region defined in a width direction orthogonal to the transport direction, and configured to transport, in the transport direction, the sheet bundle transported from upstream in the transport direction, a stitcher configured to bind the sheet bundle at the predetermined binding position in the transport direction, a pair of guide members arranged apart from each other with a distance in the width direction interposing the transport unit and configured to restrict a position in the width direction of the sheet bundle arranged on the transport unit, and a guide motion unit configured to move the pair of guide members in the width direction with respect to the transport unit and the stitcher, the transport unit is arranged in a region defined in the width direction, the sheet bundle transported from the upstream apparatus is arranged in the region, and the control method includes: a first control step of controlling the guide motion unit so that the stitcher is arranged at an intermediate position in the width direction between the pair of guide members; and a second control step of controlling the stitcher to bind the sheet bundle at the predetermined binding position with the stitcher being arranged at the intermediate position and being arranged at a different position from the predetermined region in which the transport unit is arranged.

According to the control method of the stitching and folding apparatus of one aspect of the present invention, the sheet bundle transported in the transport direction from the upstream apparatus is bound at the predetermined binding position by the stitch mechanism and folded at the predetermined binding position by the folding mechanism, and thereby a book can be made. Further, since the predetermined region in which the transport unit is arranged is included in the region defined in the width direction in which the sheet bundle transported from the upstream apparatus is arranged, various sizes of sheet bundles can be transported.

Further, the sheet bundle is bound at the predetermined binding position by the stitcher with the stitcher being arranged at the intermediate position in the width direction between the pair of guide members and being arranged at a different position from the predetermined region in which the transport unit that transports the sheet bundle is arranged. It is thus possible to suitably bind the sheet bundle at the center position in the width direction while preventing the stitcher from being arranged in the predetermined region in which the transport unit is arranged.

According to the present invention, it is possible to provide a stitching and folding apparatus and a control method of a stitching and folding apparatus that can suitably bind a sheet bundle at the center position in the width direction of the sheet bundle while enabling transport of various sizes of sheet bundles.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an overall view illustrating a book binding system in which collating machines, a stitching and folding apparatus, and a cutting apparatus are connected to each other.

FIG. 2 is an internal structure diagram illustrating a general configuration of the stitching and folding apparatus according to a first embodiment of the present invention.

FIG. 3 is a perspective view illustrating a stitch mechanism of the stitching and folding apparatus.

FIG. 4 is a block diagram illustrating a control configuration of the stitching and folding apparatus according to the first embodiment of the present invention.

FIG. 5 is a plan view of the stitch mechanism illustrated in FIG. 3 when viewed from above.

FIG. 6 is a diagram illustrating an example of a stitched sheet bundle made by the stitching and folding apparatus according to the first embodiment of the present invention.

FIG. 7 is a flowchart illustrating a control method of the stitching and folding apparatus according to the first embodiment of the present invention.

FIG. 8 is a plan view of the stitch mechanism when viewed from above and illustrates a state where the front end of a sheet bundle transported from the collating machine is abutted against a stopper.

FIG. 9 is a plan view of the stitch mechanism when viewed from above and illustrates a state where a stitcher is arranged at the center position in the width direction of the sheet bundle.

FIG. 10 is a flowchart illustrating a control method of a stitching and folding apparatus according to a second embodiment of the present invention.

FIG. 11 is a plan view of a stitch mechanism of the second embodiment of the present invention when viewed from above and illustrates a state where the front end of a sheet bundle transported from the collating machine is abutted against a stopper.

FIG. 12 is a plan view of the stitch mechanism of the second embodiment of the present invention when viewed from above and illustrates a state where the center position in the width direction of the sheet bundle is included in a predetermined region in which a transport belt is arranged.

### DETAILED DESCRIPTION

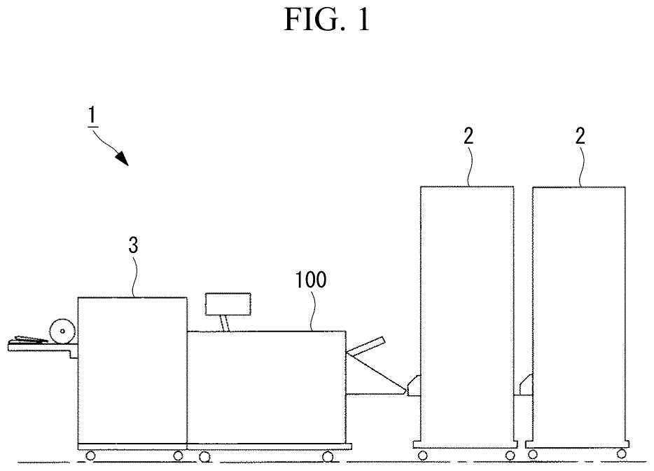

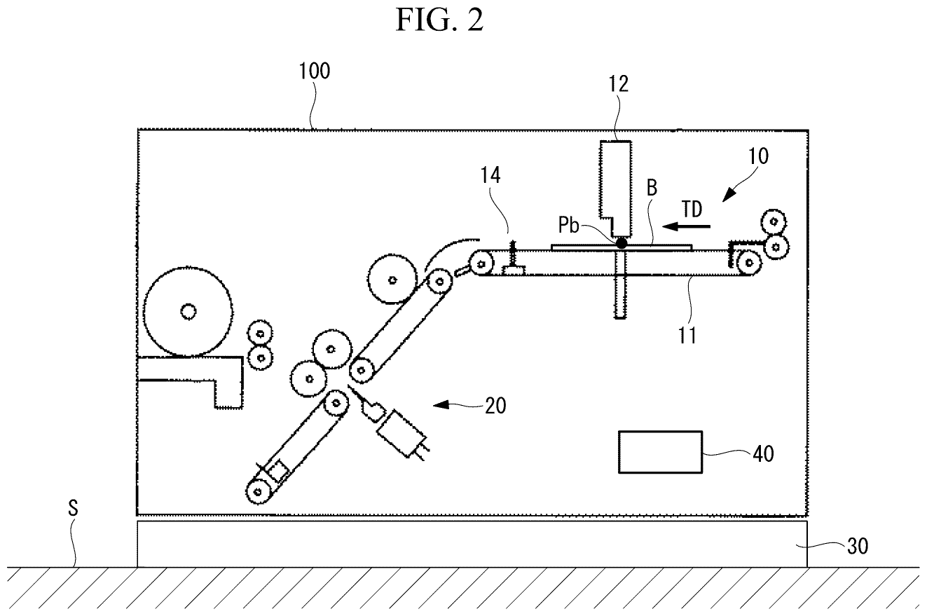

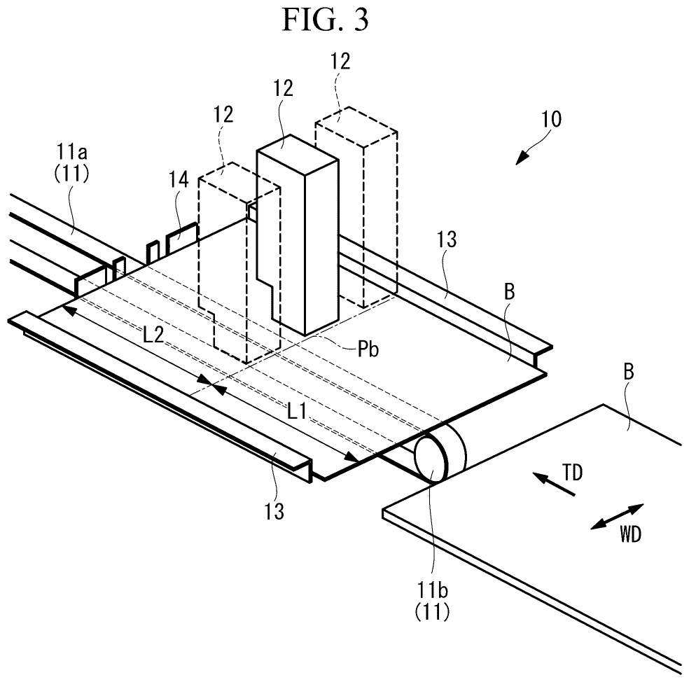

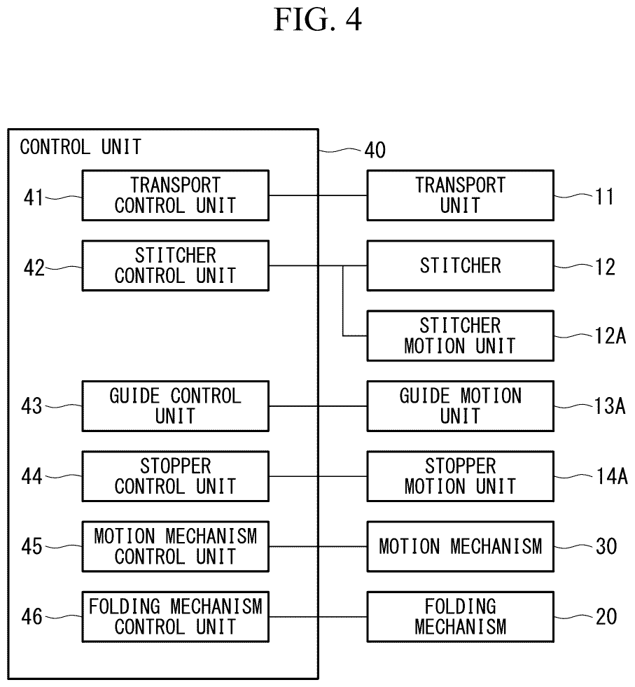

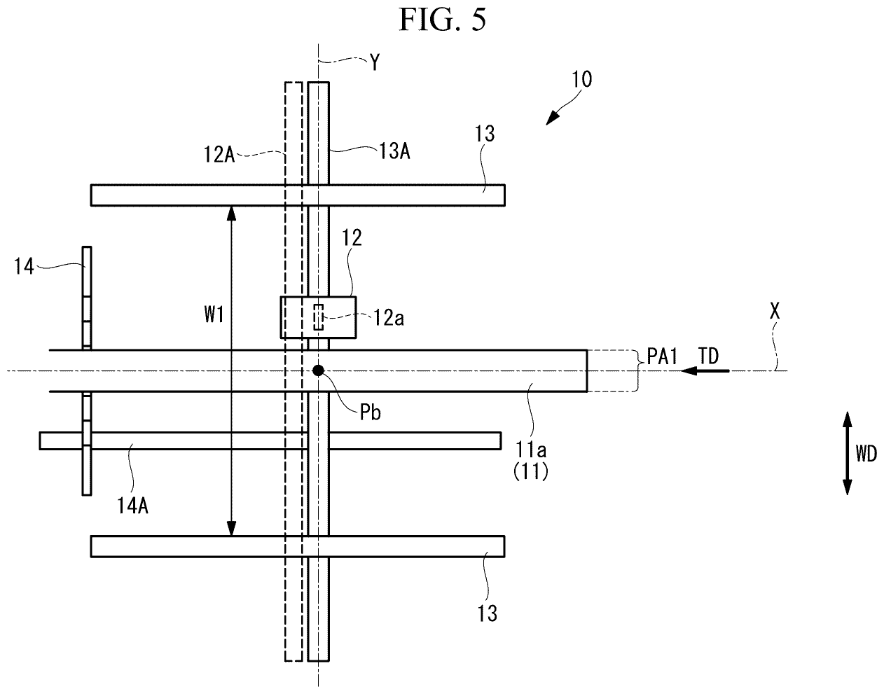

A stitching and folding apparatus 100 according to a first embodiment of the present invention will be described below with reference to the drawings. FIG. 1 is an overall view illustrating a book binding system 1 in which collating machines 2, the stitching and folding apparatus 100, and a cutting apparatus 3 are connected to each other. FIG. 2 is an internal structure diagram illustrating a general configuration of the stitching and folding apparatus 100 according to the first embodiment of the present invention. FIG. 3 is a perspective view illustrating a stitch mechanism (saddle stitch mechanism) 10 of the stitching and folding apparatus 100. FIG. 4 is a block diagram illustrating a control configuration of the stitching and folding apparatus 100 according to the first embodiment of the present invention. FIG. 5 is a plan view of the stitch mechanism 10 illustrated in FIG. 3 when viewed from above.

As illustrated in FIG. 1, the book binding system 1 includes a plurality of collating machines 2, the stitching and folding apparatus 100, and the cutting apparatus 3. Each collating machine 2 collates sheets fed from a plurality of sheet feed trays (not illustrated) in the order of pages to form a sheet bundle B and transports the sheet bundle B to the stitching and folding apparatus 100. The stitching and folding apparatus 100 makes the sheet bundle B that is a sheet bundle B bound with a wire and folded in two and then transports the bound and folded sheet bundle B to the cutting apparatus 3. The cutting apparatus 3 cuts the end of the sheet bundle B transported from the stitching and folding apparatus 100 to make a book. As illustrated in FIG. 2, the stitching and folding apparatus 100 includes a stitch mechanism 10, a folding mechanism 20, a motion mechanism 30, and a control unit 40.

The stitch mechanism 10 is a device that binds the sheet bundle B transported in the transport direction TD from the collating machine (upstream apparatus) 2 at a predetermined binding position Pb in the transport direction TD. As illustrated in FIG. 2 to FIG. 4, the stitch mechanism 10 has a transport unit 11, a stitcher 12, a stitcher motion unit 12A, a pair of guide members 13, a guide motion unit 13A, a stopper 14, and a stopper motion unit 14A.

The transport unit 11 is a device that transports, in the transport direction TD, the sheet bundle B transported from the collating machine 2 arranged upstream in the transport direction TD by rotating a transport belt 11a formed extending in the transport direction TD by a driving roller 11b. As illustrated in FIG. 5, the transport belt 11a is arranged in a predetermined region PA1 in the width direction WD orthogonal to the transport direction TD. In FIG. 5, the axis X is an axis parallel to the transport direction TD, and the axis Y is an axis parallel to the width direction WD orthogonal to the transport direction TD.

The stitcher 12 is a device that binds the sheet bundle B with a wire at a predetermined binding position Pb in the transport direction TD. As illustrated in FIG. 5, the stitcher motion unit 12A moves the stitcher 12 in the width direction WD so that a stitch region 12a in which the stitcher 12 drives a wire is a desired position in the width direction WD.

The pair of guide members 13 are members formed extending in the transport direction TD and configured to restrict the position in the width direction WD of the sheet bundle B transported by the transport unit 11. As illustrated in FIG. 5, a pair of guide members 13 are arranged apart from each other with a distance W1 in the width direction WD interposing the transport belt 11a.

The guide motion unit 13A can adjust the distance W1 in accordance with the length of the sheet bundle B in the width direction WD by moving the pair of guide members 13 closer to or away from each other in the width direction WD. Further, the guide motion unit 13A can move the pair of guide members 13 to a particular position in the width direction WD with respect to the transport belt 11a and the stitcher 12 while maintaining the distance W1 between the pair of guide members 13.

The stopper 14 is a member for stopping the front end of the sheet bundle B transported by the transport unit 11 in the transport direction TD at a desired position in the transport direction TD. The stopper 14 is a plate-like member formed extending in the width direction WD. The stopper motion unit 14A moves the stopper 14 to a desired position in the transport direction TD in accordance with the length in the transport direction TD of the sheet bundle B carried into the stitch mechanism 10.

The folding mechanism 20 is a mechanism that folds the sheet bundle B bound at a predetermined binding position Pb by the stitch mechanism 10 in two at a predetermined binding position Pb.

The motion mechanism 30 is a mechanism that moves the stitch mechanism 10 and the folding mechanism 20 to a desired position along the width direction WD orthogonal to the transport direction TD of the sheet bundle B.

The control unit 40 is a device that controls the stitching and folding apparatus 100. The control unit 40 controls the stitch mechanism 10 to bind the sheet bundle B transported from the collating machine 2 at the predetermined binding position Pb in the transport direction TD. Further, the control unit 40 controls the folding mechanism 20 to fold, at the predetermined binding position Pb, the sheet bundle B bound at the predetermined binding position Pb.

As illustrated in FIG. 4, the control unit 40 has a transport control unit 41 that controls the transport unit 11, a stitcher control unit 42 that controls the stitcher 12 and the stitcher motion unit 12A, a guide control unit 43 that controls the guide motion unit 13A, a stopper control unit 44 that controls the stopper motion unit 14A, the motion mechanism control unit 45 that controls the motion mechanism 30, and a folding mechanism control unit 46 that controls the folding mechanism 20.

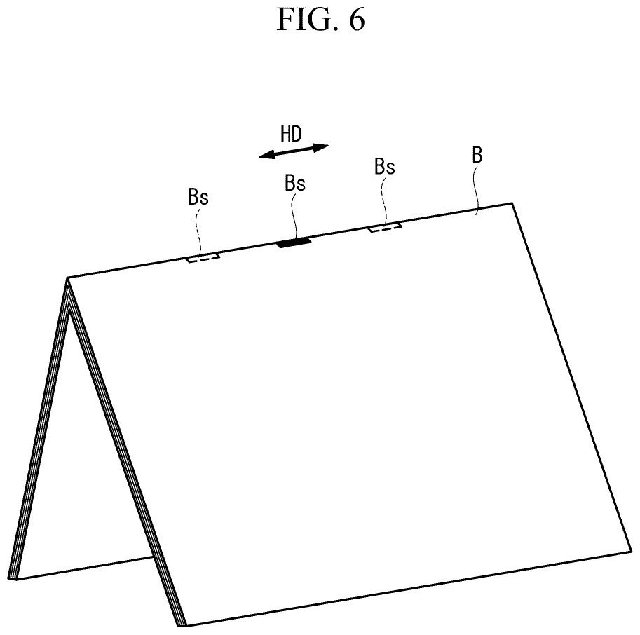

The sheet bundle B made by the stitching and folding apparatus 100 will now be described with reference to FIG. 6. FIG. 6 is a diagram illustrating an example of a stitched sheet bundle made by the stitching and folding apparatus 100 according to the first embodiment of the present invention. As illustrated in FIG. 6, the sheet bundle B made by the stitching and folding apparatus 100 is bound with a wire Bs at the center position in the height direction HD of the back part. When a single stitcher 12 illustrated by the solid line in FIG. 3 is used, the back part of the sheet bundle B made by the stitching and folding apparatus 100 will be bound with the wire Bs at a single point.

Further, the sheet bundle B made by the stitching and folding apparatus 100 may bound with the wires Bs at the center position in the height direction HD of the back part and another two points of positions arranged at the same distance from the center position. In such a case, it is desirable to use another two stitchers 12 illustrated by the dotted lines in FIG. 3 in addition to the stitcher 12 illustrated by the solid line in FIG. 3. In such a case, the back part of the sheet bundle B made by the stitching and folding apparatus 100 is bound with the wires Bs at three points.

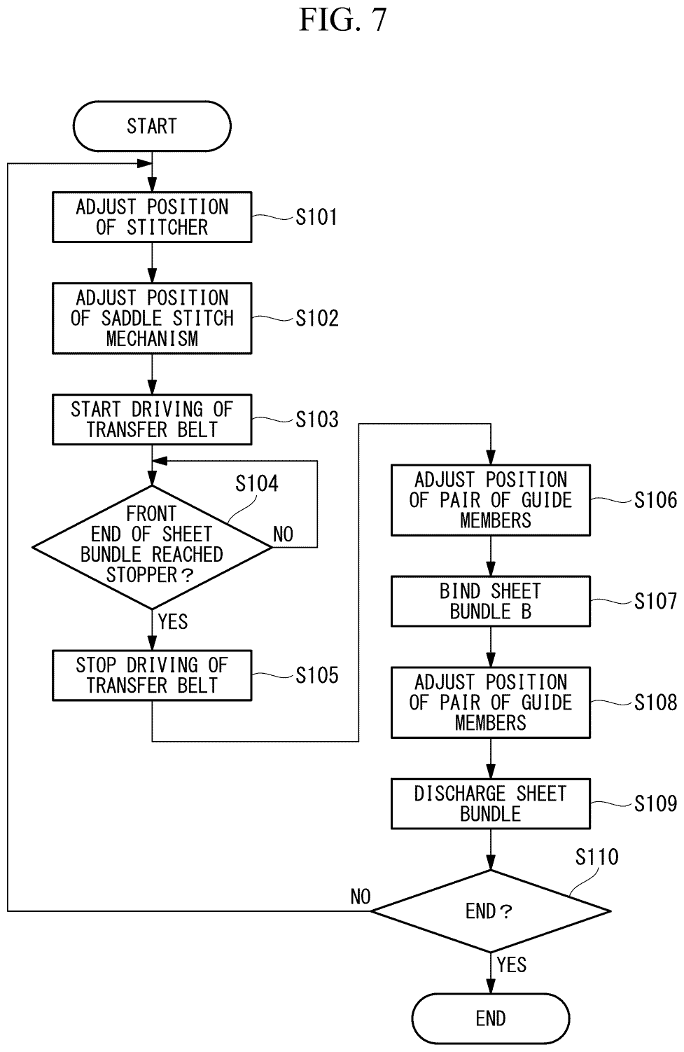

Next, the control method of the stitching and folding apparatus 100 of the present embodiment will be described with reference to FIG. 7 to FIG. 9. FIG. 7 is a flowchart illustrating the control method of the stitching and folding apparatus according to the first embodiment of the present invention. Each process illustrated in FIG. 7 is performed by a control program of the control unit 40.

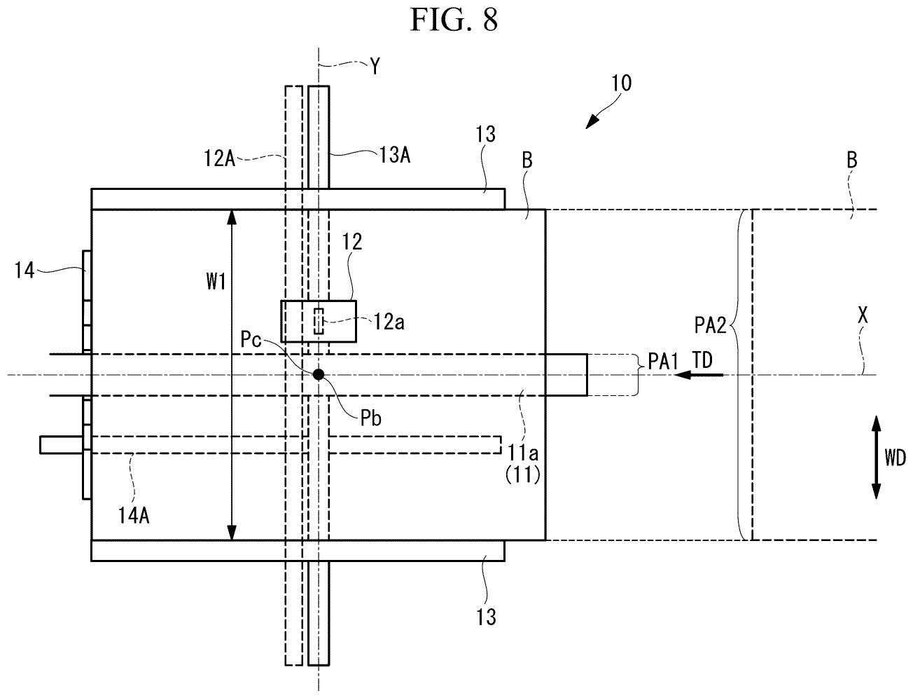

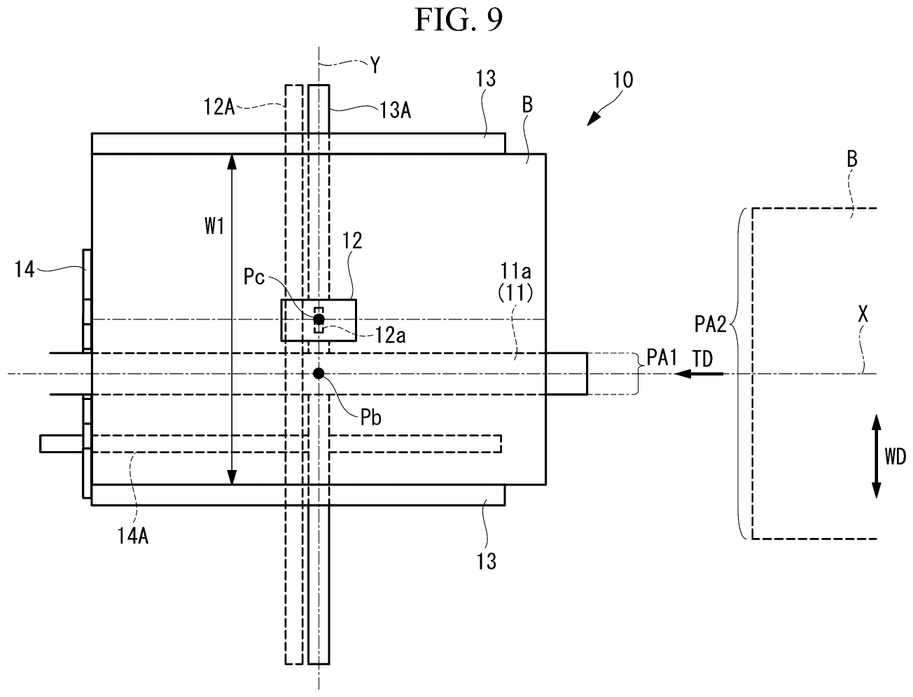

FIG. 8 is a plan view of the stitch mechanism 10 when viewed from above and illustrates a state where the front end of the sheet bundle B transported from the collating machine 2 is abutted against the stopper 14. FIG. 9 is a plan view of the stitch mechanism 10 when viewed from above and illustrates a state where the stitcher 12 is arranged at the center position Pc in the width direction WD of the sheet bundle B.

In step S101, the stitcher control unit 42 controls the stitcher motion unit 12A so that the stitcher 12 is arranged at a different position from the predetermined region PA1 in the width direction WD in which the transport belt 11a is arranged. As illustrated in FIG. 8, the stitcher control unit 42 controls the stitcher motion unit 12A so that the stitcher 12 is arranged at a position adjacent to the predetermined region PA1 in the width direction WD in which the transport belt 11a is arranged.

In step S102, the motion mechanism control unit 45 controls the motion mechanism 30 so that the predetermined region PA1 in which the transport belt 11a is arranged is included in a predetermined region PA2 defined in the width direction WD in which the sheet bundle B transported from the collating machine 2 is arranged. Specifically, the motion mechanism control unit 45 controls the motion mechanism 30 so that the center position Pc in the width direction WD of the sheet bundle B transported from the collating machine 2 is arranged in the predetermined region PA1.

In step S103, the transport control unit 41 controls the transport unit 11 to start driving of the transport belt 11a. The transport belt 11a transports the sheet bundle B transported from the collating machine 2 to the stopper 14 along the transport direction TD. Note that the position in the transport direction TD of the stopper 14 is adjusted by the stopper control unit 44 in advance in accordance with the size in the transport direction TD of the sheet bundle B.

In step S104, the control unit 40 determines whether or not the front end of the sheet bundle B has reached the stopper 14 based on the output from a sensor (not illustrated), and the control unit 40 proceeds with the process to step S105 if the determination is YES or repeats the process of step S104 if the determination is NO.

In step S105, the transport control unit 41 controls the transport unit 11 to stop the driving of the transport belt 11a. When the driving of the transport belt 11a stops, the state illustrated in FIG. 8 where the front end of the sheet bundle B is abutted against the stopper 14 is obtained.

In step S106, the guide control unit 43 controls the guide motion unit 13A so that the stitcher 12 is arranged at the center position Pc in the width direction WD between the pair of guide members 13 and obtains the state illustrated in FIG. 9.

In step S107, the stitcher control unit 42 controls the stitcher 12 to bind the sheet bundle B at the predetermined binding position Pb with the stitcher 12 being arranged at the center position Pc of the sheet bundle B and being arranged at a different position from the predetermined region PA1 in which the transport belt 11a is arranged.

In step S108, the guide control unit 43 controls the guide motion unit 13A so that the center position Pc of the sheet bundle B bound at the predetermined binding position Pb by the stitcher 12 is included in the predetermined region PA1. The guide motion unit 13A moves the pair of guide members 13 in the width direction WD back to the state illustrated in FIG. 8.

In step S109, the transport control unit 41 operates the transport belt 11a to discharge the sheet bundle B to the folding mechanism 20. Herein, the stopper control unit 44 moves the stopper 14 to a retracted position where the sheet bundle B does not come into contact with the stopper 14 so that the sheet bundle B can be discharged to the folding mechanism 20.

In step S110, the control unit 40 detects whether or not there is a sheet bundle B subsequently transported from the collating machine 2. If there is no sheet bundle B subsequently transported from the collating machine 2, the control unit 40 determines to terminate the process of the present flowchart and ends the process of the present flowchart. If there is a sheet bundle B subsequently transported from the collating machine 2, the control unit 40 again performs the process from steps S101 to S109.

The effects and advantages achieved by the stitching and folding apparatus 100 of the present embodiment described above will be described.

According to the stitching and folding apparatus 100 of the present embodiment, the sheet bundle B transported in the transport direction TD from the upstream collating machine 2 is bound at the predetermined binding position Pb by the stitch mechanism 10 and folded at the predetermined binding position Pb by the folding mechanism 20, and thereby a book can be made. Further, since the predetermined region PA1 in which the transport belt 11a is arranged is included in the region PA2 defined in the width direction WD in which the sheet bundle B transported from the collating machine 2 is arranged, various sizes of the sheet bundles B can be transported.

Further, the sheet bundle B is bound at the predetermined binding position Pb by the stitcher 12 with the stitcher 12 being arranged at the center position Pc in the width direction WD between the pair of guide members 13 and being arranged at a different position from the predetermined region PA1 in which the transport belt 11a that transports the sheet bundle B is arranged. It is thus possible to suitably bind the sheet bundle B at the center position Pc in the width direction WD while preventing the stitcher 12 from being arranged in the predetermined region PA1 in which the transport belt 11a is arranged.

According to the stitching and folding apparatus 100 of the present embodiment, the pair of guide members are moved so that, after the sheet bundle B transported from the collating machine 2 is accepted between a pair of guide members 13, the stitcher 12 is arranged at an intermediate position between the pair of guide members 13, and this makes it possible to suitably bind the sheet bundle B at the center position Pc in the width direction WD.

According to the stitching and folding apparatus 100 of the present embodiment, the sheet bundle B moved in the width direction WD for binding the sheet bundle B by the stitcher 12 can be transported to the folding mechanism 20 after returned to the position in the width direction WD applied when the sheet bundle B is carried in from the collating machine 2.

According to the stitching and folding apparatus 100 of the present embodiment, the stitcher motion unit 12A arranges the stitcher 12 at a different position from the predetermined region PA1 in which the transport belt 11a is arranged, and thereby it is possible to suitably prevent the stitcher from being arranged in the predetermined region PA1 in which the transport belt 11a is arranged.

Next, the stitching and folding apparatus 100 according to a second embodiment of the present invention will be described with reference to the drawings.

The stitching and folding apparatus 100 of the first embodiment moves a pair of guide members so that the stitcher 12 is arranged at an intermediate position between the pair of guide members 13 after accepting the sheet bundle B transported from the collating machine 2 between the pair of guide members 13 and thereby suitably binds the sheet bundle B at the center position Pc in the width direction WD.

In contrast, the stitching and folding apparatus 100 of the present embodiment moves a pair of guide members 13 so that the stitcher 12 is arranged at an intermediate position between the pair of guide members 13 before accepting the sheet bundle B transported from the collating machine 2 between the pair of guide members 13 and thereby suitably binds the sheet bundle B, which is accepted between the pair of guide members 13, at the center position Pc in the width direction WD,

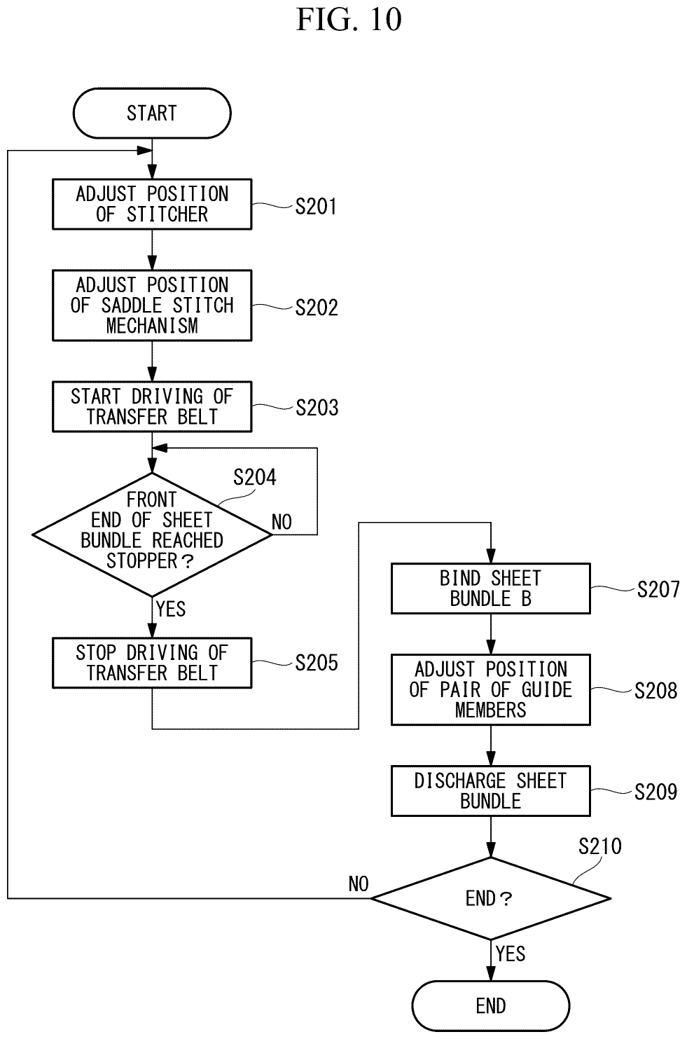

The control method of the stitching and folding apparatus 100 of the present embodiment will be described with reference to FIG. 10 to FIG. 12. FIG. 10 is a flowchart illustrating the control method of the stitching and folding apparatus according to a second embodiment of the present invention. Each process illustrated in FIG. 10 is performed by a control program of the control unit 40.

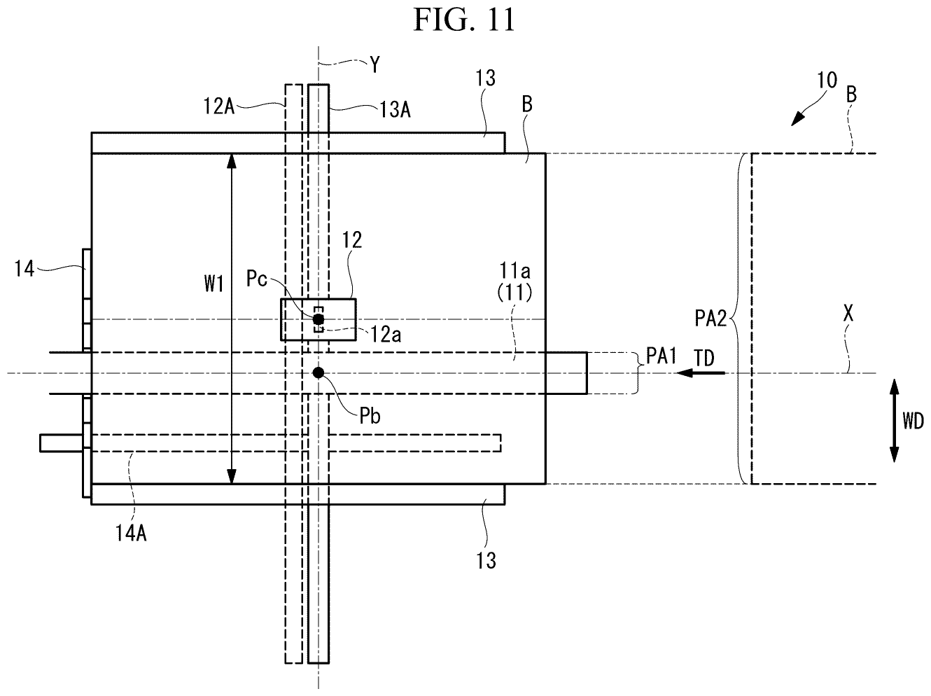

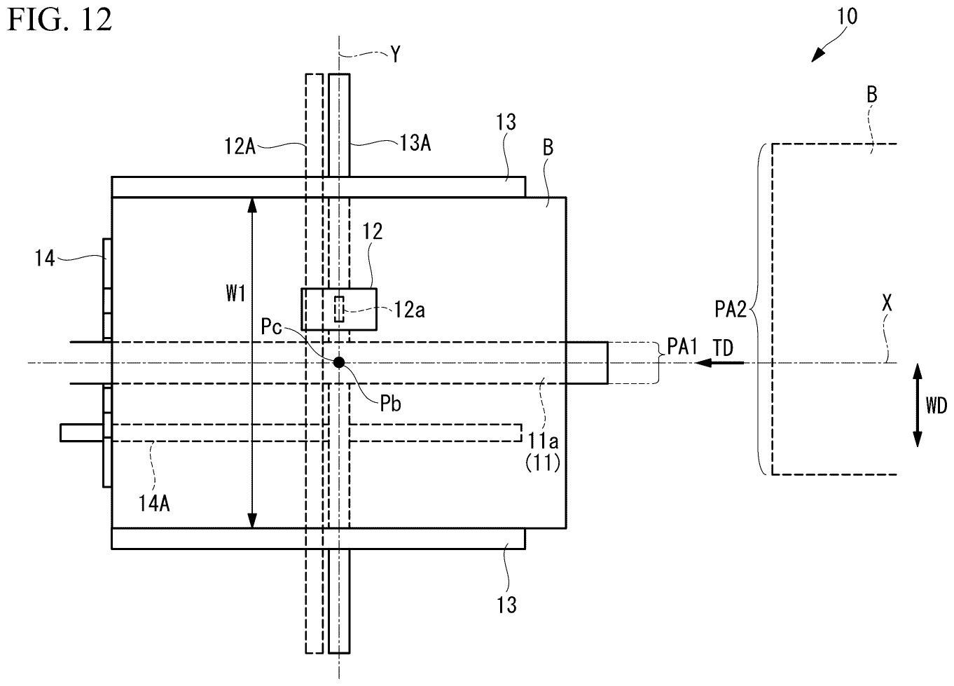

FIG. 11 is a plan view of the stitch mechanism 10 of the second embodiment of the present invention when viewed from above and illustrates a state where the front end of the sheet bundle B transported from the collating machine 2 is abutted against the stopper 14. FIG. 12 is a plan view of the stitch mechanism 10 of the second embodiment of the present invention when viewed from above and illustrates a state where the center position Pc in the width direction WD of the sheet bundle B is included in the predetermined region PA1 in which the transport belt 11a is arranged.

Since the processes of steps S201, S203, S204, S205, S207, and S210 in the flowchart of the present embodiment are the same as the processes of steps S101, S103, S104, S105, S107, and S110 in the flowchart of the first embodiment, the description thereof will be omitted below.

In step S202, the motion mechanism control unit 45 controls the motion mechanism 30 so that the stitcher 12 is arranged at the center position Pc in the width direction WD of the sheet bundle B transported from the collating machine 2. As illustrated in FIG. 11, in the present embodiment, before the sheet bundle B transported from the collating machine 2 is accepted between the pair of guide members 13, the stitcher 12 is arranged at an intermediate position between the pair of guide members 13.

Note that, in the flowchart of the present embodiment, there is no process corresponding to step S106 of the flowchart of the first embodiment. This is because the stitching and folding apparatus 100 of the first embodiment moves the pair of guide members so that the stitcher 12 is arranged at the intermediate position between the pair of guide members 13 after accepting the sheet bundle B transported from the collating machine 2 between the pair of guide members 13.

In step S208, the guide control unit 43 controls the guide motion unit 13A so that the center position Pc of the sheet bundle B bound at the predetermined binding position Pb by the stitcher 12 is included in the predetermined region PA1. The guide motion unit 13A moves the pair of guide members 13 in the width direction WD and obtains the state illustrated in FIG. 12.

In step S209, the transport control unit 41 operates the transport belt 11a to discharge the sheet bundle B to the folding mechanism 20. Herein, the stopper control unit 44 moves the stopper 14 to a retracted position where the sheet bundle B does not come into contact with the stopper 14 so that the sheet bundle B can be discharged to the folding mechanism 20.

According to the stitching and folding apparatus 100 of the present embodiment, the pair of guide members 13 is moved so that the stitcher 12 is arranged at an intermediate position between the pair of guide members 13 before accepting the sheet bundle B transported from the collating machine 2 between the pair of guide members 13, and this makes it possible to suitably bind the sheet bundle B, which is accepted between the pair of guide members 13, at the center position Pc in the width direction WD.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A stitching and folding apparatus comprising:
a stitch mechanism configured to bind a sheet bundle at a predetermined binding position in a transport direction, the sheet bundle being transported in the transport direction from an upstream apparatus;
a folding mechanism configured to fold, at the predetermined binding position, the sheet bundle bound at the predetermined binding position by the stitch mechanism;
and a control unit configured to control the stitching and folding apparatus, wherein the stitch mechanism includes a transport unit formed extending in the transport direction, arranged in a predetermined region defined in a width direction orthogonal to the transport direction, and configured to transport, in the transport direction, the sheet bundle transported from upstream in the transport direction, a stitcher configured to bind the sheet bundle at the predetermined binding position in the transport direction, a pair of guide members arranged apart from each other with a distance in the width direction interposing the transport unit and configured to restrict a position in the width direction of the sheet bundle arranged on the transport unit, and a guide motion unit configured to move the pair of guide members in the width direction with respect to the transport unit and the stitcher, wherein the transport unit is arranged in a region defined in the width direction, the sheet bundle transported from the upstream apparatus being arranged in the region, and wherein the control unit is configured to control the guide motion unit so that the stitcher is arranged at an intermediate position in the width direction between the pair of guide members, and control the stitcher to bind the sheet bundle at the predetermined binding position with the stitcher being arranged at the intermediate position and being arranged at a different position from the predetermined region in which the transport unit is arranged.

2. The stitching and folding apparatus according to claim 1, wherein the control unit is configured to control the guide motion unit so that the stitcher is arranged at the intermediate position with the sheet bundle being arranged between the pair of guide members, and control the stitcher to bind the sheet bundle at the predetermined binding position with the stitcher being arranged at the intermediate position.

3. The stitching and folding apparatus according to claim 2 further comprising a motion mechanism configured to move the stitch mechanism in the width direction, wherein the control unit is configured to control the motion mechanism so that the center position in the width direction of the sheet bundle transported from the upstream apparatus is arranged in the predetermined region.

4. The stitching and folding apparatus according to claim 1 further comprising a motion mechanism configured to move the stitch mechanism in the width direction, wherein the control unit is configured to control the motion mechanism so that the stitcher is arranged at the center position in the width direction of the sheet bundle transported from the upstream apparatus, and control the stitcher to bind the sheet bundle at the predetermined binding position with the stitcher being arranged at the intermediate position.

5. The stitching and folding apparatus according to claim 1, wherein the control unit is configured to control the guide motion unit so that the center position in the width direction of the sheet bundle bound at the predetermined binding position by the stitcher is included in the predetermined region, and control the transport unit to transport the sheet bundle to the folding mechanism, the center position of the sheet bundle being arranged to be included in the predetermined region.

6. The stitching and folding apparatus according to claim 1, wherein the stitch mechanism has a stitcher motion unit configured to move the stitcher in the width direction with respect to the transport unit, and wherein the control unit is configured to control the stitcher motion unit so that the stitcher is arranged at a different position from the predetermined region in which the transport unit is arranged.

7. A control method of a stitching and folding apparatus, wherein the stitching and folding apparatus has a stitch mechanism configured to bind a sheet bundle at a predetermined binding position in a transport direction, the sheet bundle being transported in the transport direction from an upstream apparatus, and a folding mechanism configured to fold, at the predetermined binding position, the sheet bundle bound at the predetermined binding position by the stitch mechanism, wherein the stitch mechanism has a transport unit formed extending in the transport direction, arranged in a predetermined region defined in a width direction orthogonal to the transport direction, and configured to transport, in the transport direction, the sheet bundle transported from upstream in the transport direction, a stitcher configured to bind the sheet bundle at the predetermined binding position in the transport direction, a pair of guide members arranged apart from each other with a distance in the width direction interposing the transport unit and configured to restrict a position in the width direction of the sheet bundle arranged on the transport unit, and a guide motion unit configured to move the pair of guide members in the width direction with respect to the transport unit and the stitcher, and wherein the transport unit is arranged in a region defined in the width direction, the sheet bundle transported from the upstream apparatus being arranged in the region, the control method comprising:
a first control step of controlling the guide motion unit so that the stitcher is arranged at an intermediate position in the width direction between the pair of guide members; and
a second control step of controlling the stitcher to bind the sheet bundle at the predetermined binding position with the stitcher being arranged at the intermediate position and being arranged at a different position from the predetermined region in which the transport unit is arranged.

8. The control method of the stitching and folding apparatus according to claim 1, wherein the first control step is configured to control the guide motion unit so that the stitcher is arranged at the intermediate position with the sheet bundle being arranged between the pair of guide members, and the second control step is configured to control the stitcher to bind the sheet bundle at the predetermined binding position with the stitcher being arranged at the intermediate position.

9. The control method of the stitching and folding apparatus according to claim 8, the stitching and folding apparatus further comprising a motion mechanism configured to move the stitch mechanism in the width direction, wherein the control method further comprising:
a third control step of controlling the motion mechanism so that the center position in the width direction of the sheet bundle transported from the upstream apparatus is arranged in the predetermined region.

10. The control method of the stitching and folding apparatus according to claim 7, the stitching and folding apparatus further comprising a motion mechanism configured to move the stitch mechanism in the width direction, wherein the control method further comprising:
a fourth control step of controlling the motion mechanism so that the stitcher is arranged at the center position in the width direction of the sheet bundle transported from the upstream apparatus, and wherein the second control step is configured to control the stitcher to bind the sheet bundle at the predetermined binding position with the stitcher being arranged at the intermediate position.

11. The control method of the stitching and folding apparatus according to claim 7, wherein the control method further comprising:
a fifth control step of controlling the guide motion unit so that the center position in the width direction of the sheet bundle bound at the predetermined binding position by the stitcher is included in the predetermined region, and a sixth control step of controlling the transport unit to transport the sheet bundle to the folding mechanism, the center position of the sheet bundle being arranged to be included in the predetermined region.

12. The control method of the stitching and folding apparatus according to claim 7, wherein the stitch mechanism has a stitcher motion unit configured to move the stitcher in the width direction with respect to the transport unit, wherein the control method further comprising:
a seventh control step of controlling the stitcher motion unit so that the stitcher is arranged at a different position from the predetermined region in which the transport unit is arranged.
